(19) United States
(12) Patent Application Publication
(10) Pub. No.: US 2007/0240114 A1
(43) Pub. Date: Oct. 11, 2007

(54) Testing Transformed Interfaces

(75) Inventor: John G. Dallman, Cambridge (GB)

Correspondence Address: UGS CORP., 5800 GRANITE PARKWAY, SUITE 600, PLANO, TX, 75024, US

(73) Assignee: UGS Corp., Plano, TX (US)

(21) Appl. No.: 11/278,038

(22) Filed: Mar. 30, 2006

(51) Int. Cl. G06F 9/44

(52) U.S. Cl. 717/124

(57) ABSTRACT

A system, method, and computer program for testing a transformed interface, comprising the steps of receiving a plurality of test data by a reverse transformed interface, wherein said reverse transformed interface translates said test data; and transmitting said translated test data to a transformed interface, wherein said transformed interface operates with an original application to return a plurality of testing replies and appropriate means and computer-readable instructions

### TECHNICAL FIELD

This presently preferred embodiment relates generally to software design. More specifically, the presently preferred embodiment relates to a system and method of testing transformed interfaces.

### BACKGROUND

As methods of software programming evolve, so do the software languages to adequately reflect that change. When software developers create new programs, the need sometimes arises to interface them with a prior-written original program necessitating the need for to code a software interface. To create those interfaces, software developers often code function calls or dynamically linked libraries (DLL's), sometimes alternatively referred to as wrappers, transformed or altered interfaces, that act as an interface between the newly developed program and the original program.

To facilitate the evolution of coding a modern front-end interface with the original program, solutions exist, e.g. SWIG (www.swig.org), to generate code for such transformed interface layers from higher-level descriptions such as C header files or CORBA IDL files. However, a problem arises when testing the new interface with the original program. Specifically, all of the man-years of prior debugging and testing was performed under the original software interface/back-end paradigm. Due to the application of the new interface, a new set of test data has to be fed into the interface, to test and debug before release.

Notwithstanding the chosen programming language, the methodology for software development remains the same where the testing process is integral to development. Software is difficult to test; it must be tested either by humans, who are slow, prone to errors, and get bored easily when asked to do repetitive tasks, or by other software, which must itself be written and tested. For multiple interfaces, the testing software needs to be re-written, which imposes large costs and creates a future cost-burden as it is updated, and leads to the creation of multiple testing suites.

Rather than using humans to test software, the better choice is to use a testing software application. Effective testing software, while not necessarily (or usually) commercial, represents a large fraction of the costs of developing good software. And reducing the costs associated with testing, benefits the efficiency of the software development process. Software for testing an interface is normally tied to the form of that interface and cannot be re-used to test a transformed form of that interface. As used in this disclosure, the interface is a programming layer that one application uses to send or receive calls to/from other applications. And the form is the software language the interface, or any program/application, is coded in. For example, an application written in C can have an interface for other C applications—all of the same form. And if the programmer wants an application written in C++ to use his C program, a new interface must be written in the same form C or in a new form like C++, which depends on whether the C language is able to handle calls from a C++ program, but this is understood in the art of software programming. To put it another way, for the C++ application to call or make use of the C application, the programmer writes a “wrapper” that translates C++ calls to C and vice versa.

The software, tools, samples of data input and output, and configurations are all generally referred to as a “test harness.” The test harness is the testing infrastructure that is created to support a specific program or tool. Each specific program or tool can have multiple test suites that are all supported by a single test harness.

There is a need for a solution that creates adequate testing software for the transformed interfaces with the facility to exercise all elements of the new interface, feed any chosen data into them, evaluate and summarize the results, and assist in the correction of errors in the interface and underlying software. There is also the need to automate the creating of test code and test data for the new interface to eliminate the creation of test suites.

### SUMMARY

To overcome the problems of the prior art, and in accordance with the purpose of the presently preferred embodiment as broadly described herein, the presently preferred embodiment provides a method for testing a transformed interface, comprising the steps of receiving a plurality of test data by a reverse transformed interface, wherein said reverse transformed interface translates said test data; and transmitting said translated test data to a transformed interface, wherein said transformed interface operates with an original application to return a plurality of testing replies. The method further comprising the step of evaluating said testing replies. The method, wherein said plurality of test data is generated by a test harness. The method, wherein said test harness and said original application are written in a first programming language, and said transformed interface is written in a second programming language.

An advantage of the presently preferred embodiment is to provide a computer-program product tangibly embodied in a machine readable medium to perform a method for testing a transformed interface, comprising: instructions for receiving a plurality of test data by a reverse transformed interface, wherein said reverse transformed interface translates said test data; and instructions for transmitting said modified test data to a transformed interface, wherein said transformed interface operates with an original application to return a plurality of testing replies. The computer-program product, further comprising the instructions for evaluating said testing replies. The computer-program product, wherein said plurality of test data is generated by a test harness. The computer-program product, wherein said test harness and said original application are written in a first programming language, and said transformed interface is written in a second programming language.

Another advantage of the presently preferred embodiment is to provide a data processing system having at least a processor and accessible memory, comprising means for receiving a plurality of test data by a reverse transformed interface, wherein said reverse transformed interface translates said test data; and means for transmitting said modified test data to a transformed interface, wherein said transformed interface operates with an original application to return a plurality of testing replies.

Still another advantage of the presently preferred embodiment is to provide a computer-program product validated by a testing process, the testing process comprising a reverse transformed interface that receives a plurality of test data and returns a plurality of translated test data, whereby said computer-program product communicates with an original application using said translated test data for result evaluation. The computer-program product, wherein said plurality of test data is generated by a test harness. The computer-program product, wherein said test harness and said original application are written in a first programming language, and said computer-program product is written in a second programming language.

And yet another advantage of the presently preferred embodiment is to provide a reverse transformed interface embodied on a computer-readable medium for execution on a computer in conjunction with a testing application, the reverse transformed interface comprising a modified implementation of an original interface that receives a plurality of test data to translate for transmitting, and a calling layer that returns a plurality of translated test data to a transformed interface.

A further advantage of the presently preferred embodiment is to provide a method to embody a reverse transformed interface on a computer-readable medium for execution on a computer in conjunction with a testing application, comprising the steps of implementing a modified original interface that receives a plurality of translated test data, and returning a plurality of replies to a reverse transformed interface for evaluation by a testing application.

Still another further advantage of the presently preferred embodiment is to provide a method for testing a transformed interface, comprising the steps of receiving a plurality of test data by a reverse transformed interface, wherein said reverse transformed interface translates said test data between a first programming language and a second programming language; transmitting said translated test data to a transformed interface written in said second programming language, wherein said transformed interface operates with an original application written in said first programming language; and evaluating a plurality of testing replies.

Other advantages of the presently preferred embodiment will be set forth in part in the description and in the drawings that follow, and, in part will be learned by practice of the presently preferred embodiment.

The presently preferred embodiment will now be described with reference made to the following Figures that form a part hereof, and which is shown, by way of illustration, an embodiment of the presently preferred embodiment. It is understood that other embodiments may be utilized and changes may be made without departing from the scope of the presently preferred embodiment.

### BRIEF DESCRIPTION OF THE DRAWINGS

A preferred exemplary embodiment of the presently preferred embodiment will hereinafter be described in conjunction with the appended drawings, wherein like designations denote like elements, and:

FIG. 1 is a block diagram of a computer environment in which the presently preferred embodiment may be practiced;

FIG. 2 is a logic flow diagram,

FIG. 3 is a logic flow diagram with a transformed interface,

FIG. 4 is a logic flow diagram with a transformed interface and a reverse transformed interface, and

FIG. 5 is a logic flow diagram illustrating the sequential steps of the preferred embodiment.

### DETAILED DESCRIPTION OF THE PREFERRED EMBODIMENTS

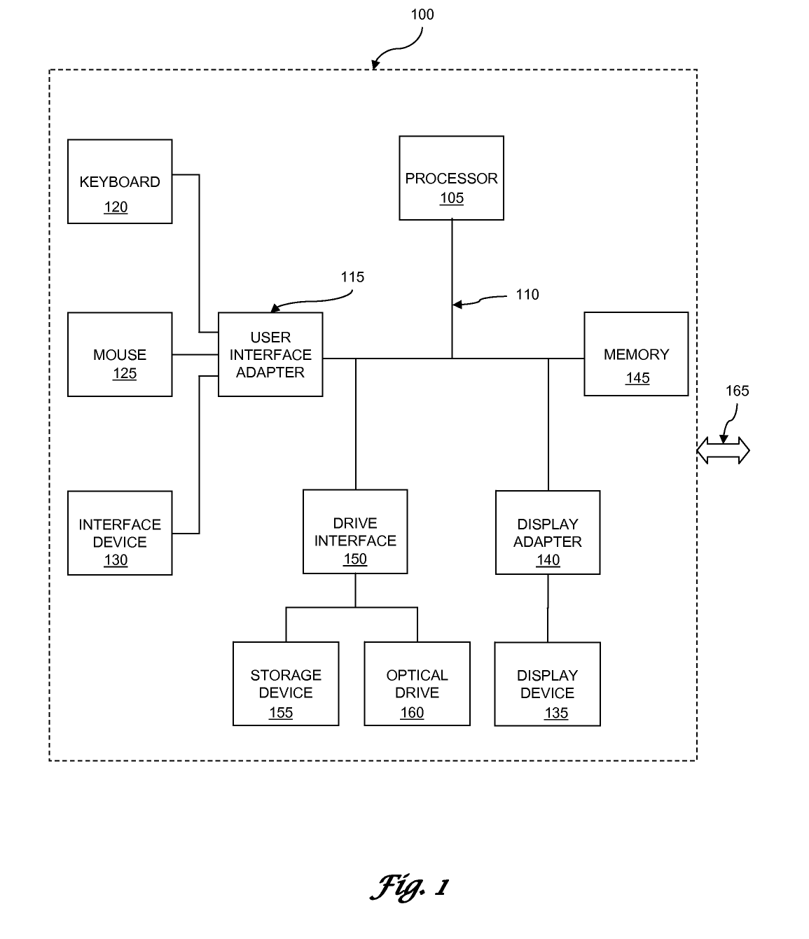

The numerous innovative teachings of the present application will be discussed with particular reference to the presently preferred embodiments. It should be understood, however, that this class of embodiments provides only a few examples of the many advantageous uses of the innovative teaching herein. The presently preferred embodiments provide, among other things, a system and method for testing transformed interfaces. FIG. 1 and the following discussion are intended to provide a brief, general description of a suitable computing environment in which the presently preferred embodiments may be implemented. Although not required, the presently preferred embodiments will be described in the general context of computer-executable instructions, such as program modules, being executed by a personal computer. Generally program modules include routines, programs, objects, components, data structures, etc., that perform particular tasks or implement particular abstract data types. Likewise, the presently preferred embodiments may be performed in any of a variety of known computing environments.

With reference to FIG. 1, an exemplary system for implementing the presently preferred embodiments includes a general-purpose computing device in the form of a computer 100, such as a desktop or laptop computer, including a plurality of related peripheral devices (not depicted). The computer 100 includes a microprocessor 105 and a bus 110 employed to connect and enable communication between the microprocessor 105 and a plurality of components of the computer 100 in accordance with known techniques. The bus 110 may be any of several types of bus structures including a memory bus or memory controller, a peripheral bus, and a local bus using any of a variety of bus architectures. The computer 100 typically includes a user interface adapter 115, which connects the microprocessor 105 via the bus 110 to one or more interface devices, such as a keyboard 120, mouse 125, and/or other interface devices 130, which can be any user interface device, such as a touch sensitive screen, digitized pen entry pad, etc. The bus 110 also connects a display device 135, such as an LCD screen or monitor, to the microprocessor 105 via a display adapter 140. The bus 110 also connects the microprocessor 105 to a memory 145, which can include ROM, RAM, etc.

The computer 100 further includes a drive interface 150 that couples at least one storage device 155 and/or at least one optical drive 160 to the bus. The storage device 155 can include a hard disk drive, not shown, for reading and writing to a disk, a magnetic disk drive, not shown, for reading from or writing to a removable magnetic disk drive. Likewise the optical drive 160 can include an optical disk drive, not shown, for reading from or writing to a removable optical disk such as a CD ROM or other optical media. The aforementioned drives and associated computer-readable media provide non-volatile storage of computer readable instructions, data structures, program modules, and other data for the computer 100.

The computer 100 can communicate via a communications channel 165 with other computers or networks of computers. The computer 100 may be associated with such other computers in a local area network (LAN) or a wide area network (WAN), or it can be a client in a client/server arrangement with another computer, etc. Furthermore, the presently preferred embodiment may also be practiced in distributed computing environments where tasks are performed by remote processing devices that are linked through a communications network. In a distributed computing environment, program modules may be located in both local and remote memory storage devices. All of these configurations, as well as the appropriate communications hardware and software, are known in the art.

Software programming code that embodies the presently preferred embodiment is typically stored in the memory 145 of the computer 100. In the client/server arrangement, such software programming code may be stored with memory associated with a server. The software programming code may also be embodied on any of a variety of non-volatile data storage device, such as a hard-drive, a diskette or a CD-ROM. The code may be distributed on such media, or may be distributed to users from the memory of one computer system over a network of some type to other computer systems for use by users of such other systems. The techniques and methods for embodying software program code on physical media and/or distributing software code via networks are well known and will not be further discussed herein.

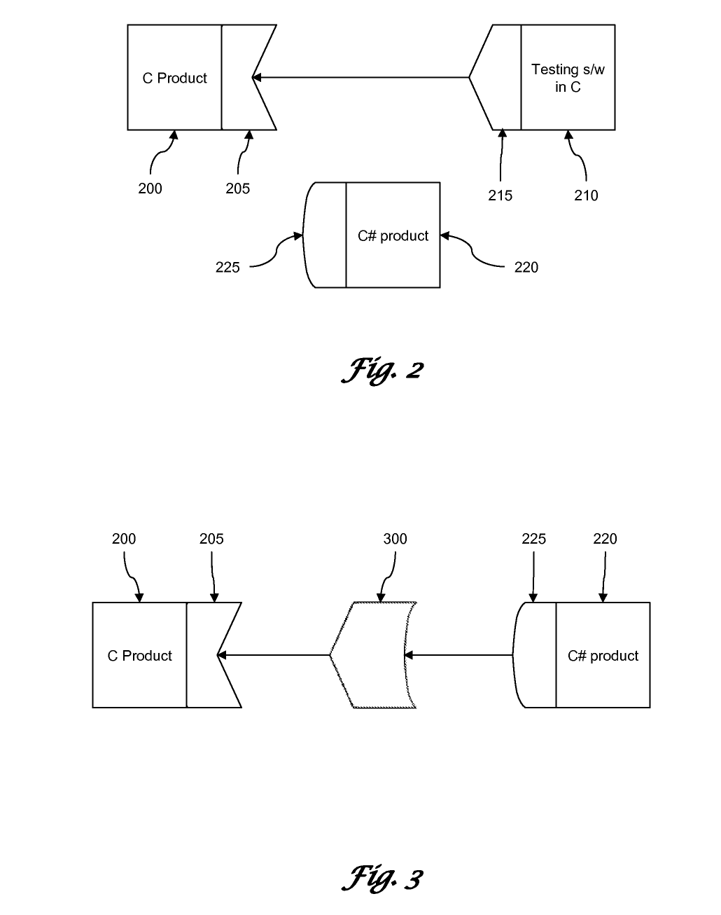

FIG. 2 is a logic flow diagram, where the presently preferred embodiment discloses a method for testing a transformed interface where a software designer has an original software product 200 written in a first software language, for example C, with an original interface 205. The original interface 205 receives calls from other programs written in the first software language for processing, as illustrated in Table 1.

TABLE 1

| | |
|---|---|
| typedef int FOO_error_t; | /* type to hold error codes */ |
| typedef int FOO_BAR_t; | /* identifying number of a FOO_BAR */ |
| FOO_error_t FOO_BAR_format( FOO_BAR_t entity, char ** buffer); | |

For example, the software designer created the original software product 200 that is an original library of functions, referred to as a “kernel” in this example. The kernel is designed as a toolkit of component software to embed in a third-party product. Programmed along with the kernel is the original interface 205, referred to as a kernel interface in this example. The kernel interface accepts calls from the third-party product that uses the library functions available in the kernel.

Continuing the development of the original software product 200, the designer creates a test harness or a testing program 210, also written in the first software language, C, where Table 2 illustrates simple C code for testing FOO_BAR_format.

TABLE 2

char *buffptr;
FOO_BAR_t e = create_test_entity( );
if( FOO_BAR_format( e, &buffptr) = = FOO_ok)

```
{
  int I = strlen( buffptr);
  if( I < 1) testing_error( “returned string too short”);
  if( I > 79) testing_error( “returned string too long”);
  testing_success( buffptr);
}
```

In this simplified example, the code tests the length of the string of characters to determine if it is within normal length parameters. The testing program 210 can take many man-months, if not man-years to create and fine-tune proper the necessary testing harness for the original software product 200.

The testing program 210 utilizes an original calling layer 215 that is also written in the first software language, C, to communicate with the original software product 200 where the original interface 205 receives the calls from the testing program 210 for processing by the original software product 200 for the purpose of sending test data to and from the original software product 200 to test designed responses.

As additional software development occurs, a third party developer creates a third party product 220 that has a third party calling layer 225 both of which are written in a second software language that is discrete from the original software product 200 and the original interface 205—where discrete means separate, for example C# are C++ are discrete programming languages from one another.

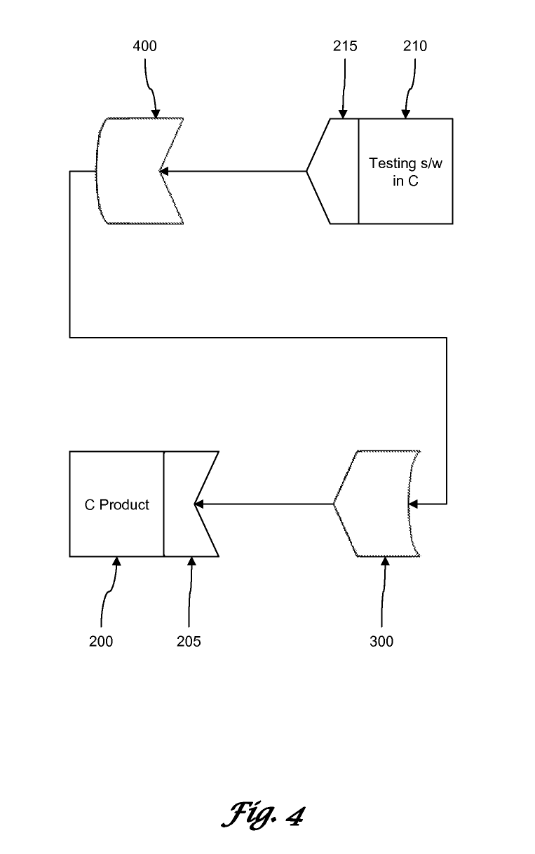

FIG. 3 is a logic flow diagram with a transformed interface, where the first software designer codes a transformed interface 300 that is written in the discrete software language to provide the ability for the third party programs written to communicate with the original software product 200. Many programming languages have the facility to use software components written in another language, requiring proper declarations in the necessary style and form to do so. For example, the C# language has the ability to call functions written in C, as illustrated in Table 3.

TABLE 3
namespace FOO
{
partial class BAR

```
{
  [DllImport(“foo.dll”, CallingConvention=CallingConvention.Cdecl,
  CharSet=CharSet.Ansi, EntryPoint=“FOO_BAR_format”)]
  public static extern FOO.error_t format( FOO.BAR_t entity,
  byte ** buffer);
};
```

};

This table illustrates the transformed interface 300 wherein the discrete software language written in C#, for example, calls the FOO_BAR_format function from Table 1. It is understood that the transformed interface 300 is also referred to as a “wrapper” in the industry, as the transformed interface 300 “wraps” around the original software product 200 and the original interface 205 to make the original interface 205 usable to the third-party application in the discrete programming language that cannot otherwise properly make the function calls or utilize the necessary libraries provided by the original software product 200. A benefit of the use of the wrapper is that an older program can be utilized and updated for use by the most recently programmed applications utilizing the newest in software techniques, so long as the necessary wrappers are available for the original software product 200.

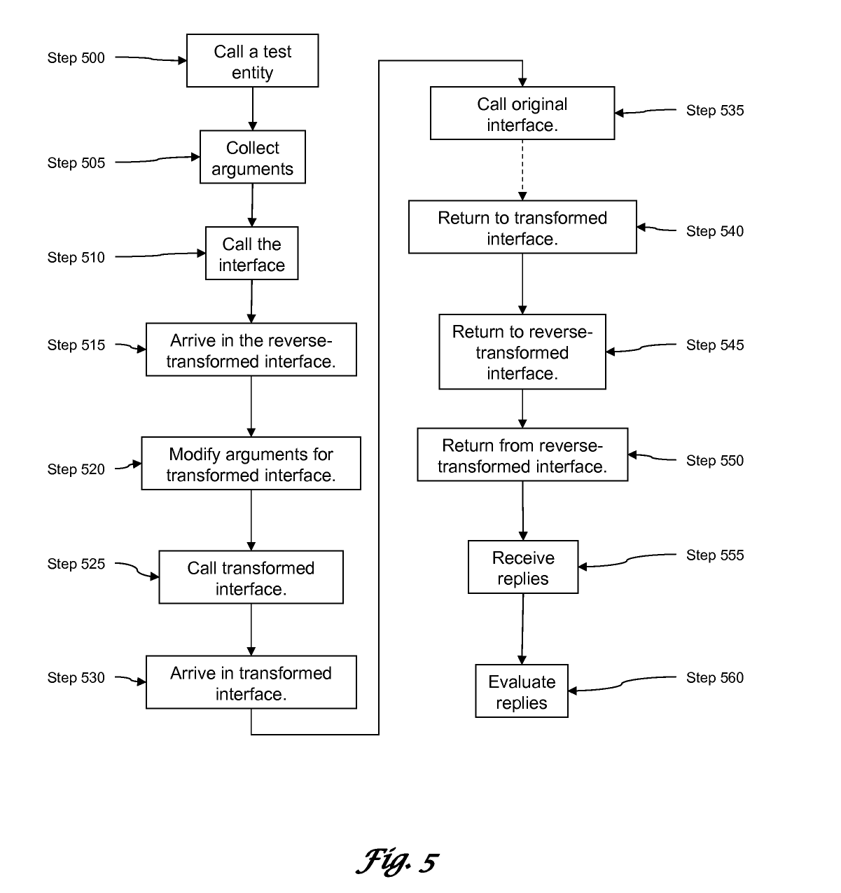

Turning now to FIG. 4, a logic flow diagram with a transformed interface and a reverse transformed interface, a reverse transformed interface 400 receives calls written in the first programming language, modifies the calls and arguments, then sends the modified calls and arguments to the transformed interface 300. Likewise, the transformed interface 300 receives calls from the reverse transformed interface 400 and returns calls to the original interface 205. Now, the testing program 210 sends its calls not to the original interface 205, but to the transformed interface 300 thanks to the translation by the reverse transformed interface 400. For example, the designer codes the reverse transformed interface 400 in an other software language like C++, that can create functions callable from the first software language, C, and call functions written in the second software language, C#, as illustrated in Table 4, below.

TABLE 4
FOO::BAR_t makefromFOO_BAR_t( FOO_BAR_t a)

{
FOO::BAR_t b = FOO::BAR_t((int)a);
return b;
}

typedef unsigned char byte;
byte **makepointerchar( char **a)

{
byte ** b;
b = (byte **) a;
return b;
}

FOO_error_t FOO_BAR_format( FOO_BAR_t entity, char **buffptr)

{
return (FOO_error_t) FOO::BAR::format(

makefromFOO_BAR_t( entity),
makepointerchar( buffptr));

}

The coding overhead for writing the reverse transformed interface 400 may be significant, but it is still a fraction of the overhead required to modify a large body of the testing program 210.

FIG. 5 is a the logic flow diagram illustrating the sequential steps of the presently preferred embodiment. To begin, the preferred embodiment initiates a test harness like the testing program 210 (Step 500), where arguments are collected (Step 505) and sent to the original interface 205 (Step 510). The arguments arrive at the reverse transformed interface 400 (Step 515), where they are modified for the transformed interface 300 (Step 520). The reverse transformed interface 400 then calls the transformed interface 300 (Step 525) where the modified arguments arrive (Step 530). The transformed interface 300 then sends the modified arguments to the original interface 205 (Step 535) where the original software product 200 executes its program using the original testing arguments, but modified to test the transformed interface 300.

Continuing, the original software product 200 returns its output to the transformed interface 300 (Step 540), which is then returned via an output method to the reverse transformed interface 400 (Step 545). The reverse transformed interface 400 sends the resultant output (Step 550) to the testing program 210 that then evaluates the output replies (Step 560).

In an alternate embodiment, the software designer may create the transformed interface 300 that is a subset of the original interface 205, require that part of the original interface 205 still be used for testing. Also, extra interfaces may be required to offer additional ways of using parts of the original interface 205. There are numerous ways in which the presently preferred embodiment could be implemented, using various ways of describing the original interface 205 to be supported and the ways in which it is to be tested.

The presently preferred embodiment can be coded in a code generating program utilizing a scripting language like PERL, for example, or any reasonably powerful programming language. The code generating program automatically generates “wrappers” according to the methods outlined above that wrap around a software product written in C or C++, like Parasolid® by UGS Corp., and makes its interfaces usable to a programming language like C#.

The presently preferred embodiment may also be implemented in digital electronic circuitry, or in computer hardware, firmware, software, or in combinations thereof. An apparatus of the presently preferred embodiment may be implemented in a computer program product tangibly embodied in a machine-readable storage device for execution by a programmable processor; and method steps of the presently preferred embodiment may be performed by a programmable processor executing a program of instructions to perform functions of the presently preferred embodiment by operating on input data and generating output.

The presently preferred embodiment may advantageously be implemented in one or more computer programs that are executable on a programmable system including at least one programmable processor coupled to receive data and instructions from, and to transmit data and instructions to, a data storage system, at least one input device, and at least one output device. The application program may be implemented in a high-level procedural or object-oriented programming language, or in assembly or machine language if desired; and in any case, the language may be a compiled or interpreted language.

Generally, a processor will receive instructions and data from a read-only memory and/or a random access memory. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially-designed ASICs (application-specific integrated circuits).

A presently preferred embodiment has been described. It will be understood that various modifications may be made without departing from the spirit and scope of the presently preferred embodiment. Therefore, other implementations are within the scope of the following claims. For example, extra interfaces receive and return calls to offer extra methods of using various parts of the interface. Alternatively, the interfaces can be created in such a way that the new program is a subset of tested programs. Likewise, the presently preferred embodiment, as disclosed, can have its operations split into several parts, for example, for batch processing or for load balancing so that several machines to handle various aspects of the calculations and processing load.

What is claimed is:

1. A method for testing a transformed interface, comprising the steps of:
receiving a plurality of test data by a reverse transformed interface, wherein said reverse transformed interface translates said test data; and
transmitting said translated test data to a transformed interface, wherein said transformed interface operates with an original application to return a plurality of testing replies.

2. The method of claim 1, further comprising the step of evaluating said testing replies.

3. The method of claim 1, wherein said plurality of test data is generated by a test harness.

4. The method of claim 1,
wherein
said test harness and said original application are written in a first programming language, and
said transformed interface is written in a second programming language.

5. A computer-program product tangibly embodied in a machine readable medium to perform a method for testing a transformed interface, comprising:
instructions for receiving a plurality of test data by a reverse transformed interface, wherein said reverse transformed interface translates said test data; and
instructions for transmitting said modified test data to a transformed interface, wherein said transformed interface operates with an original application to return a plurality of testing replies.

6. The computer-program product of claim 5, further comprising the instructions for evaluating said testing replies.

7. The computer-program product of claim 5, wherein said plurality of test data is generated by a test harness.

8. The computer-program product of claim 5,
wherein
said test harness and said original application are written in a first programming language, and
said transformed interface is written in a second programming language.

9. A data processing system having at least a processor and accessible memory, comprising:
means for receiving a plurality of test data by a reverse transformed interface, wherein said reverse transformed interface translates said test data; and
means for transmitting said modified test data to a transformed interface, wherein said transformed interface operates with an original application to return a plurality of testing replies.

10. A computer-program product validated by a testing process, the testing process comprising:
a reverse transformed interface that receives a plurality of test data and returns a plurality of translated test data,
whereby said computer-program product communicates with an original application using said translated test data for result evaluation.

11. The computer-program product of claim 10, wherein said plurality of test data is generated by a test harness.

12. The computer-program product of claim 10,
wherein
said test harness and said original application are written in a first programming language, and
said computer-program product is written in a second programming language.

13. A reverse transformed interface embodied on a computer-readable medium for execution on a computer in conjunction with a testing application, the reverse transformed interface comprising:
a modified implementation of an original interface that receives a plurality of test data to translate for transmitting, and
a calling layer that returns a plurality of translated test data to a transformed interface.

14. A method to embody a reverse transformed interface on a computer-readable medium for execution on a computer in conjunction with a testing application, comprising the steps of:
implementing a modified original interface that receives a plurality of translated test data, and
returning a plurality of replies to a reverse transformed interface for evaluation by a testing application.

15. A method for testing a transformed interface, comprising the steps of:
receiving a plurality of test data by a reverse transformed interface, wherein said reverse transformed interface translates said test data between a first programming language and a second programming language;
transmitting said translated test data to a transformed interface written in said second programming language, wherein said transformed interface operates with an original application written in said first programming language; and
evaluating a plurality of testing replies.
